(19) United States
(12) Patent Application Publication
(10) Pub. No.: US 2006/0041651 A1
(43) Pub. Date: Feb. 23, 2006

(54) Shared airport terminal equipment with peripheral management

(75) Inventors: Robert Walcutt, Orlando, FL (US); Ray Vecchiarelli, Winter Park, FL (US); Betros Wakim, Windermere, FL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Air-Transport IT Services, Inc., Naperville, IL (US)

(21) Appl. No.: 10/869,606

(22) Filed: Jun. 16, 2004

(51) Int. Cl. G06F 15/173

(52) U.S. Cl. 709/223

(57) ABSTRACT

Systems and methods are described for allowing shared terminal equipment at airports. Systems embodying the invention load airlines' proprietary applications onto common commercial, off-the-shelf computers. A peripheral manager device is disclosed for facilitating communication between the common computer and peripheral devices. The peripheral manager device translates airline-specific signals to and from peripheral devices, and coordinates the switching of the common computer between an airport management network and an airline proprietary network. Systems using the peripheral device manager provide secure networks connecting the shared terminal equipment with an airline's private network.

### FIELD OF THE INVENTION

This invention pertains generally to the field of airport and transportation terminal management, and more particularly to enabling functionality of proprietary software and networks on shared computer equipment.

### BACKGROUND OF THE INVENTION

Historically, airports have leased their boarding gates and check-in counters for exclusive use to particular airline transport providers. Thus, if Airline A was the exclusive lessee of a gate, then Airline B was unable to use that gate, even during periods when Airline A was not operating any flights from that gate. When an airline is the exclusive lessee of a gate, the airline typically installs its own computer system hardware, including its own proprietary peripheral devices, running its own proprietary software applications. Such dedicated hardware is interconnected in a network that is proprietary to the airline.

However, many airports have begun to implement “common-use” passenger processing systems, which allow multiple airlines access to a single gate or check-in terminal. A challenge of implementing a common-use system is that each individual airline may have its own proprietary network and software applications, and they may not be easily compatible with the shared equipment. Existing common-use systems, such as the Common Use Terminal Equipment model proposed by the International Air Transport Association (IATA), use computer systems that have been specially configured to allow access by multiple airlines. A single platform is specified by the airport and airlines then write software that emulates their proprietary applications on the specified platform to connect with specified peripheral devices.

However, existing common-use terminal systems have several drawbacks. The need to emulate proprietary software requires additional development and testing to ensure compatibility with the underlying operating system and attached peripherals. This is particularly costly when modifications are made to the proprietary applications, since additional modifications then become necessary for the emulation program.

### SUMMARY OF THE INVENTION

Embodiments of the present invention provide systems and methods for allowing shared terminal equipment at airports. A management system loads one or more proprietary applications, rather than emulation programs, onto commercial, off-the-shelf computers. A peripheral manager device translates signals between the proprietary applications and common airport peripheral equipment. The peripheral manager device further facilitates switching the computer from an airport management network to and from an airline's proprietary network.

In one aspect of the invention, a system for managing operations at a station of a transportation terminal is provided, the station operable by any of a plurality of transportation carriers, the system comprising a computing device, a peripheral manager device connected to the computer and at least one peripheral device attached to the peripheral manager, wherein an operating system and set of applications corresponding to a first of the plurality of transportation carriers are loaded onto the computing device, and wherein the peripheral manager device is switched to a mode facilitating communication between the at least one peripheral device and the loaded set of applications on the computing device.

In another aspect of the invention, a method is provided for managing operations at a station of a transportation terminal, the station operable by any of a plurality of transportation carriers, the method comprising selecting a first transportation carrier from a user interface on a computer located at the station a computing device, loading, by the computer, an operating system and applications corresponding to the first transportation carrier, notifying a peripheral manager device connected to the computer of the selection of the first transportation carrier, and facilitating, by the peripheral manager, communication between the applications loaded on the computer and at least one peripheral device connected to the peripheral manager.

In another aspect of the invention, a peripheral manager apparatus is provided for facilitating communication between at least one peripheral device and a computer, the computer operable by any of a plurality of transportation carriers, the apparatus comprising a communications interface connected to the computer, a peripheral interface connected to the at least one peripheral device, and a controller receiving a signal corresponding to a first of the plurality of transportation carriers, and intermediating communications between the communications interface and the peripheral interface such that applications of the first transportation carrier, residing on the computer, communicate with the at least one peripheral device.

In still another aspect of the invention, a system is provided for managing resources of a transportation terminal including a gate for use by a plurality of transportation carriers, the system comprising a network for managing resources of the transportation terminal, a computer associated with the gate and connected to the network, and an access server connected to the network granting or denying access to computer, wherein granting or denying access to the computer is performed for one of the plurality of transportation carriers in congruence with managing other resources of the transportation terminal.

The invention thus offers distinct advantages over prior systems. Airlines using such systems do not require any specialized technical support to ensure their applications are compatible, nor do they require specialized training for their employees, who use their applications in precisely the same manner as they would in a proprietary system. Furthermore, embodiments of the invention provide secure networks connecting the common terminal equipment with an airline's private network.

### BRIEF DESCRIPTION OF THE DRAWINGS

While the appended claims set forth the features of the present invention with particularity, the invention and its advantages are best understood from the following detailed description taken in conjunction with the accompanying drawings, of which:

FIG. 1 is a simplified schematic illustrating an exemplary network platform for carrying out provision of common-use terminal equipment, in accordance with an embodiment of the invention;

FIG. 2 is a flow diagram illustrating a general method of providing an airline access to common-use terminal equipment, in accordance with an embodiment of the invention;

FIG. 3 is a simplified schematic illustrating an exemplary architecture of a computing device, in accordance with an embodiment of the invention;

FIG. 4 is a an illustration of a peripheral manager device for connecting a workstation to peripherals in a common-use terminal setting, in accordance with an embodiment of the invention;

FIG. 4a is a flow diagram illustrating a general method of loading translation tables and translating signals between a workstation and a peripheral manager device, in accordance with an embodiment of the invention;

FIG. 5 is a simplified schematic illustrating components of a peripheral manager device, in accordance with an embodiment of the invention;

FIG. 6 is a flow diagram illustrating a method of using multiple partitions on a hard disk to allow common-use terminal equipment, in accordance with an embodiment of the invention;

FIG. 7 is a flow diagram illustrating a method of carrying out provision of common-use terminal equipment, in accordance with an embodiment of the invention;

FIG. 8 is a diagram of a graphical user interface for selecting an airline to use a common-use terminal, in accordance with an embodiment of the invention; and

FIG. 9 is a flow diagram illustrating a method of using an airport resource manager to control access to common-use terminal equipment, in accordance with an embodiment of the invention.

### DETAILED DESCRIPTION OF THE INVENTION

The systems and methods to facilitate common-use airport terminal equipment is now described; however, the methods and systems of the present invention are not limited to facilitating common-use airport terminal equipment. Moreover, the skilled artisan will readily appreciate that the methods and systems described herein are merely exemplary and that variations can be made without departing from the spirit and scope of the invention.

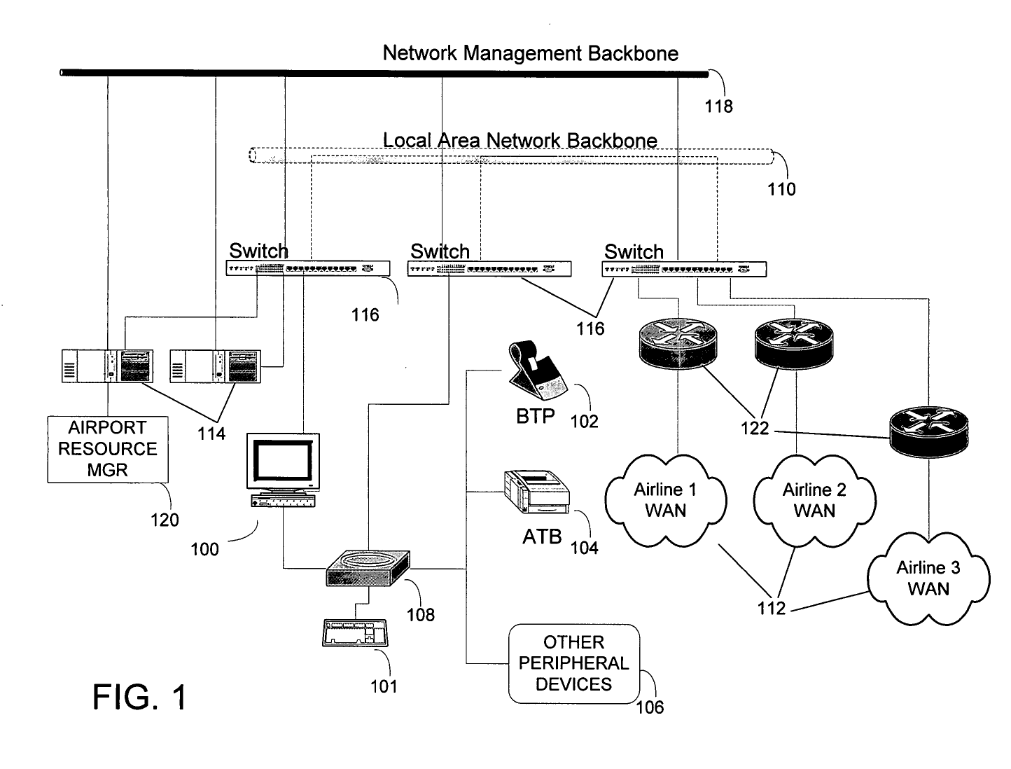

The present invention will be more completely understood through the following detailed description, which should be read in conjunction with the attached drawings. In this description, like numbers refer to similar elements within various embodiments of the present invention. An embodiment of the invention is implemented on a network platform as shown in FIG. 1. A computer workstation 100 is located at an airport gate, check-in counter, or other terminal station. The workstation 100 is preferably a commercial, “off-the-shelf” computer based on the Intel Pentium family of CPUs. More details on the exemplary workstation 100 are described below. The workstation 100 is connected locally to keyboard 101 and various peripherals, such as a baggage tag printer (BTP) 102, automated ticketing & boarding machine (ATB) 104, boarding gate reader (BGR), report printer (RP), or other peripheral devices 106. The peripheral devices are preferably Association of European Airlines (AEA) compatible, and may be accessed by either serial connections, parallel connections, or by IP sockets. A peripheral manager device 108 (PMD) connects the peripherals to the workstation 100. More details on the PMD 108 are described below.

In an embodiment of the invention, the network platform comprises at least two logically separate network backbones. A local area network (LAN) backbone 110 connects the workstation 100 to both an individual airline's proprietary wide-area network (WAN) 112 and to airport management servers 114. The airport management servers 114 preferably support DHCP and TFTP. Additionally, some embodiments include a separate maintenance server for storing and retrieving workstation image partitions, holding backup and log files, and performing other housekeeping functionality. The peripheral manager device 108 is connected to the LAN backbone 110. Network switches 116 facilitate the connections between the workstation 100, the airport management servers 114, and the airline WAN 112. Alternatively, hubs and routers are used in place of or in addition to network switches 116. The LAN backbone 110, therefore, can be either a dedicated LAN or a virtual LAN (VLAN) communicating over a larger network. Switching is controlled by the airport management servers 114 through a network management backbone 118. The airport management servers 114 further may perform other airport management functions, such as gate allocation, baggage claim assignment, etc., via airport resource manager routines 120. The airline WAN 112 is typically a proprietary network connected to the LAN via a gateway or router 122, and communicates via standard or proprietary protocols, such as ALC, UTS, AX.25, MATIP, TCP/IP and others.

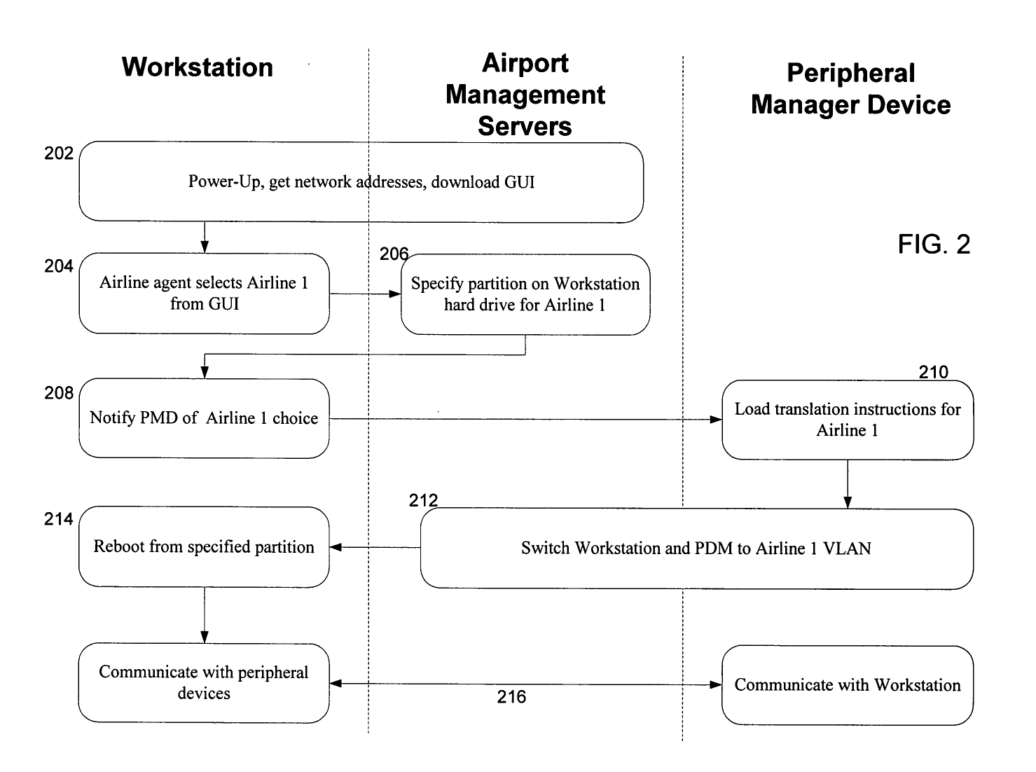

A typical scenario employing an embodiment of the invention is now described at a high level with reference to FIG. 2. More details involving this scenario are described below. In a typical scenario, the workstation 100 is powered-up at step 202, where it sends a request and receives relevant network addresses along with a graphical user interface. A representative from Airline A logs into the workstation 100, selecting Airline 1 from the downloaded GUI, and entering an authentication such as a password at step 204. The workstation 100 sends the selection to the airport management servers 114 and, at step 206, the airport management server 114 specify a partition of the hard drive of the workstation 100. The workstation 100 notifies the PMD 108 of the choice of airline at step 208, and the PMD 108 then loads the corresponding translation table 210 for the airline at step 210 to allow the software applications of Airline A to communicate with the various connected peripheral devices. The PMD 108 works with the airport management servers 114 to set the switches 116 at step 212, using the network management backbone 118, such that the workstation 100 and PMD 108 communicate with Airline A's WAN 112 in a VLAN connection. The workstation 100 is instructed to reboot from the specified partition at step 214. Booting from the partition causes Airline A's operating system and application to load onto the workstation 100. The PMD 108 also maintains a second connection to the LAN 110 in order to communicate with the airport management servers 114. In an alternative embodiment, Airline A does not have its own proprietary WAN or applications, but rather shares common applications provided via the airport management servers 114. In another alternative embodiment, the operating system and/or applications are loaded onto the workstation 100 via the network connection, rather than from a partition on the local hard drive. Once the workstation 100 is rebooted, it seamlessly communicates with the Airline A proprietary WAN via the VLAN connection, and with the various common peripheral devices via the peripheral manager device 108.

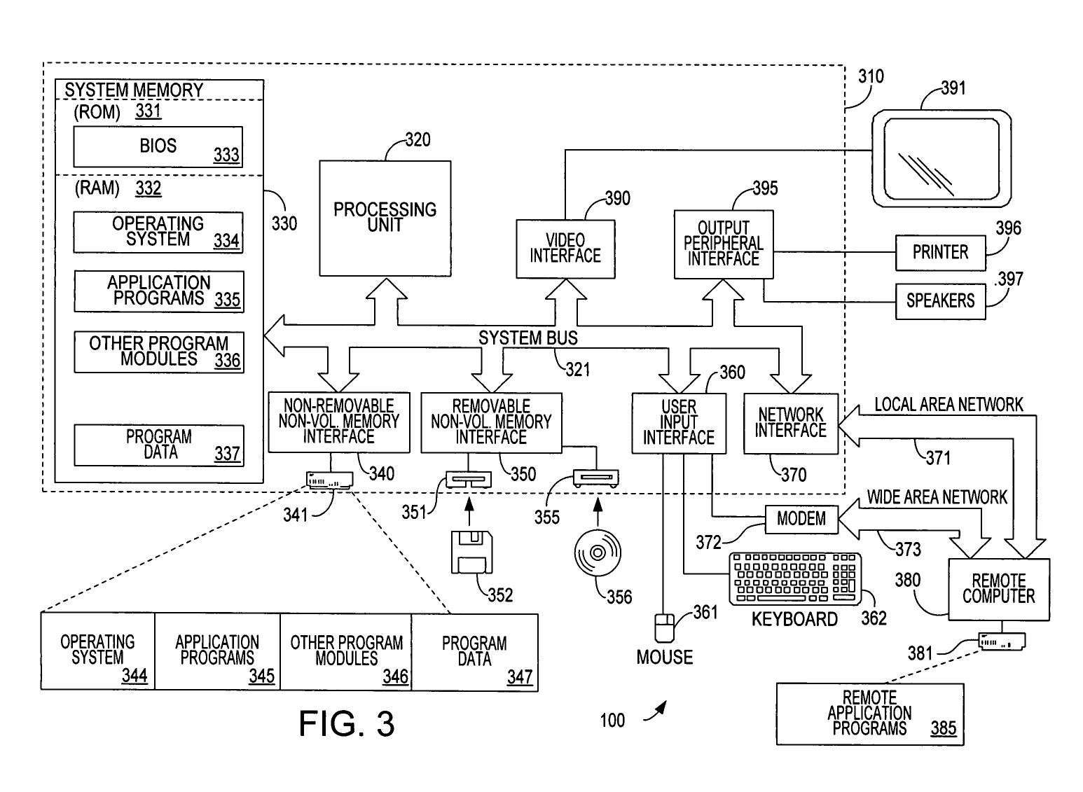

FIG. 3 illustrates an example of a workstation 100 on which the invention may be implemented. An exemplary workstation 100 for implementing the invention is a general purpose computing device in the form of a computer, which may be a commercial “off-the-shelf” computer. Components of the computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 310 typically includes a variety of computer readable media. Computer readable media can be any available media that can be accessed by the computer 310 and includes both volatile and nonvolatile media, and removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computer 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media, discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. Operating system 344, application programs 345, other program modules 346, and program data 347 are given different numbers hereto illustrate that, at a minimum, they are different copies. A user may enter commands and information into the computer 310 through input devices such as a tablet, or electronic digitizer, 364, a microphone 363, a keyboard 362 and pointing device 361, commonly referred to as a mouse, trackball or touch pad. Other input devices (not shown) may include a joystick, game pad, satellite dish, scanner, or the like. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. The monitor 391 may also be integrated with a touch-screen panel or the like. Note that the monitor and/or touch screen panel can be physically coupled to a housing in which the computing device 310 is incorporated, such as in a tablet-type personal computer. In addition, computers such as the computing device 310 may also include other peripheral output devices such as speakers 397 and printer 396, which may be connected through an output peripheral interface 394 or the like.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet. For example, in the present invention, the computer 310 may comprise the source machine from which data is being migrated, and the remote computer 380 may comprise the destination machine. Note however that source and destination machines need not be connected by a network or any other means, but instead, data may be migrated via any media capable of being written by the source platform and read by the destination platform or platforms.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360 or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

An exemplary workstation 100 supports network booting, runs a VESA compliant 640×480×256 video mode, and uses LBA addressing for hard drive sectors. At least 128 megabytes of RAM and a video card capable of supporting up to 1024×768 24-bit color are used in the exemplary workstation 100. The hard drive of the workstation 100 preferably supports at least 2 gigabytes per partition. For backwards compatibility with legacy systems, four serial (COM) ports and one parallel port are provided.

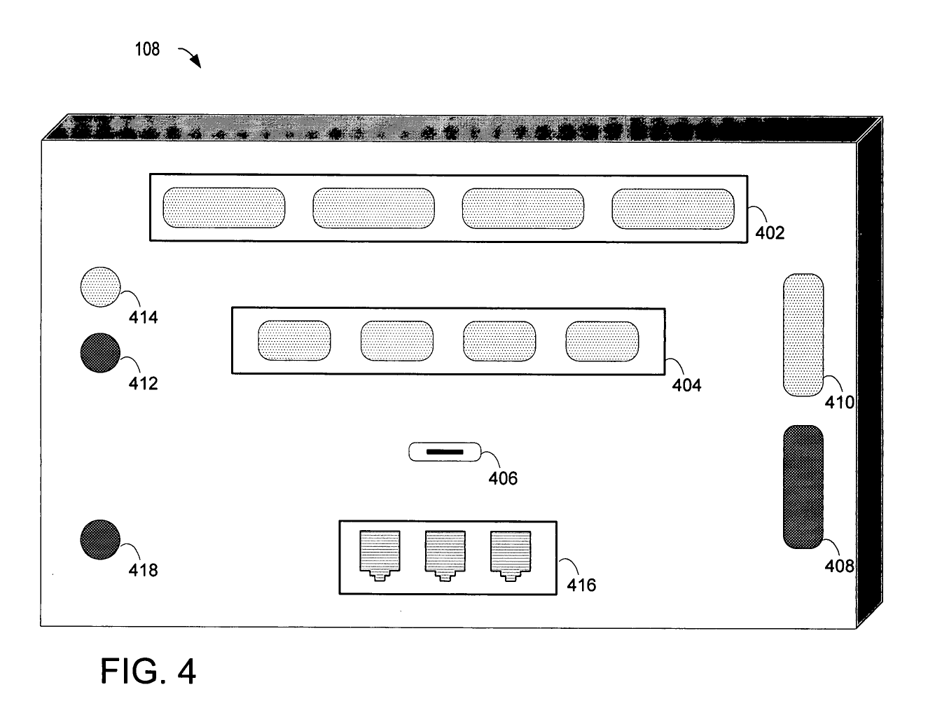

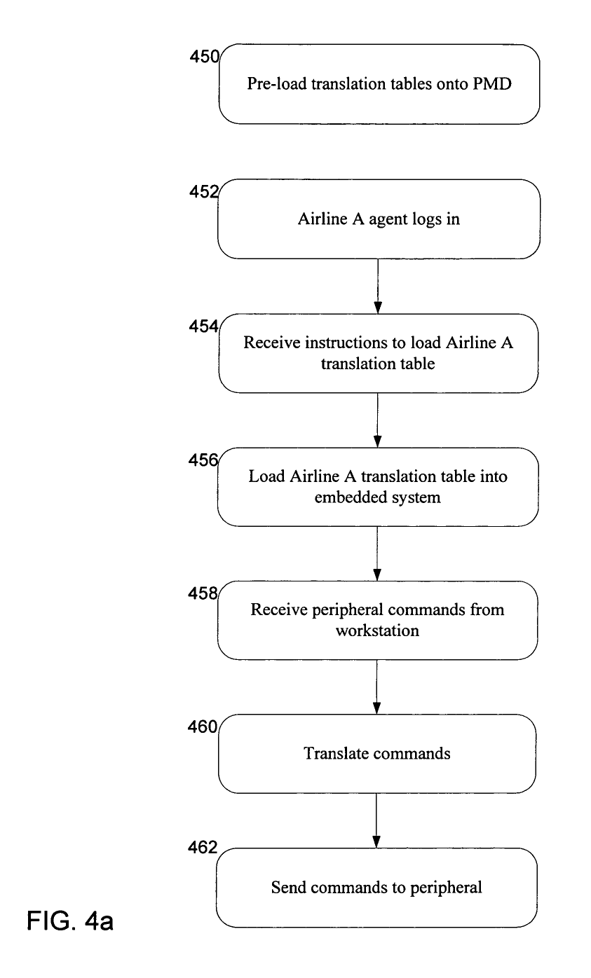

Turning to FIG. 4, the peripheral manager device 108 is now described. The PMD 108 attaches between the workstation 100 and various peripheral devices. An exemplary PMD 108, as shown in FIG. 4, contains a variety of interface ports. Although one embodiment of the invention contains all the types of ports shown, other embodiments of the invention do not contain every type of port, or may contain additional types of ports, and the absence or presence of these types of ports does not limit the scope of the invention. Several COM ports 402 are provided for connecting to the workstation 100. The COM ports 402 are preferably DB-9 female connectors. Serial ports 404 are provided for connecting to various peripheral devices, such as baggage tag readers, boarding gate readers, and the like. The Serial ports 404 are preferably DB-9 male connectors. Additionally, a universal serial bus (USB) port 406 is provided for connecting to peripheral devices. In one embodiment, an additional USB-in port is provided for connecting to the workstation 100. A parallel OUT port 408 is provided for connecting to a peripheral device such as a report printer, and a parallel IN port 410 is provided for connecting to a parallel port of the workstation 100. The parallel OUT port 408 is preferably a DB-25 female connector, and the parallel IN port 410 is preferably a DB-25 male connector. Similarly, a keyboard OUT port 412 is provided for connecting to a keyboard, and a keyboard IN port 414 is provided for connecting to a keyboard port (e.g., PS/2) of the workstation 100. Three Ethernet ports 416 (RJ-45) are provided for communicating with the airport network and an airline WAN. A control port 418, preferably a PS/2 connector, is provided for connecting to the workstation 100 in order to monitor the workstation's power-on status and to toggle the power state of the workstation 100.

Turning to FIG. 4a, a use of the peripheral device manager 108 is now described, in accordance with an embodiment of the invention. The peripheral manager device 108 translates protocols used by the various peripheral devices into those expected by an airline's software applications. In an embodiment of the invention, the peripheral device manager 108 contains firmware that is pre-loaded with translation tables for individual airlines that may use the workstation 100 at step 450. The pre-loading of translation tables is preferably accomplished in an off-line manner. In another embodiment, the PMD 108 is loaded with translation tables in an online manner, via, for example, the airport communications network. When a particular airline's representative logs into the workstation 100 at step 452, the PMD 108 receives instructions from the airport management servers at step 454, to load the translation table corresponding to that airline into an embedded system of the PMD 108 at step 456. Alternatively, the PMD 108 receives translation instructions via the workstation 100. Peripheral commands sent by the particular airline's applications running on the workstation 100 are sent to the PMD 108 at step 458, where they are translated appropriately at step 470 and passed on to the intended peripheral devices at step 462. In a similar fashion, the PMD 108 translates signals sent from the peripheral devices to the workstation, so that the signals may be understood by the particular airline's software applications. The PMD 108 thus allows the use of standard peripherals by an airline without any modification to the airline's software applications. The peripherals therefore can be specified or provided by the airport, and are not unique to the particular airline. The PMD 108 preferably uses a static internet protocol address, communicating with the airport management servers via TCP, and communicating with the workstation 100 via serial connections.

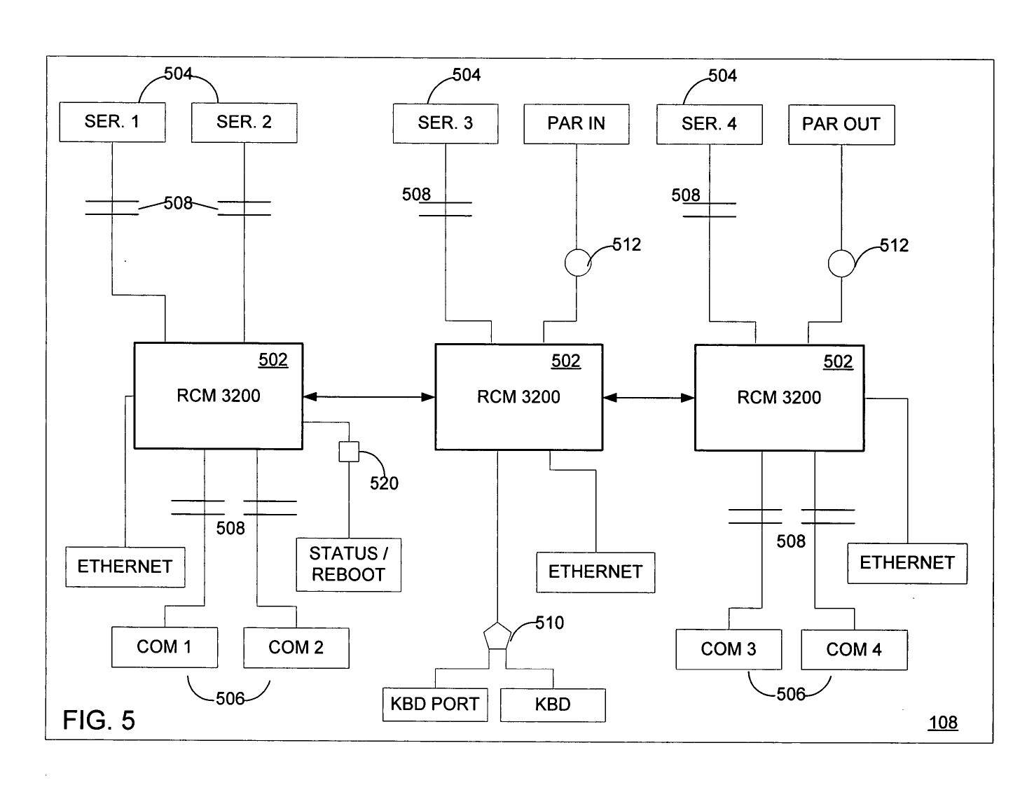

In an embodiment of the invention, the peripheral manager device 108 comprises several components, as shown in FIG. 5. At the heart of the device is an embedded system for translating between a workstation running an airline's application software and various peripherals attached to the peripheral manager device. The illustrated embedded system uses three RCM3200 modules 502, manufactured by Rabbit Semiconductor of Davis, California. Each RCM3200 502 contains a microprocessor, flash memory, program execution memory, data memory, input/output to at least six serial ports, and an Ethernet port. In one embodiment, each RCM3200 module 502 is loaded with a unique program using a serial connection from a computer device.

In an embodiment of the invention, the Serialx 504 and COMx: 506 connections pass through RS-232 to CMOS-level voltage converter components 508. The RCM3200 modules 502 operate on 3.3 volt signals, so the RS-232-level signals (which are the ‘standard’ serial signals used by workstations and peripherals) are converted down to that level as they enter the modules, and converted up as they exit, using voltage converter components 508. Keyboard signals are generally 5 volts; those signals are held at this level by the workstation and keyboard. Data is sent to and from the keyboard and workstation by ‘pulling’ these signals down to 0 with a keyboard signal conversion component 510. The parallel input ‘latches’ the incoming data with latching components 512, and tells the workstation not to send any more until it has been read by one of the RCM3200 modules 502. The parallel output data is latched and held until the acknowledges receiving it.

A keyboard component is used for translating keyboard output. Typically, keyboard output is in the form of scan codes, which have a one-to-one correspondence with standard ASCII characters. The embedded system of the peripheral manager device 108 converts between scan codes and ASCII characters. The ability to convert between scan codes and ASCII characters allows multiple airlines with different peripheral configurations to use the common workstation. For example, if one airline has a bar code reader that shares a “Y” connection with a keyboard, then the peripheral manager device 108 outputs scan codes an mimics a keyboard; if another airline uses a bar code reader that is connected via one of the peripheral manager device's COM1 ports, then the peripheral manager device 108 outputs ASCII characters.

The peripheral manager device 108 further comprises a status/reset component 520 in an embodiment of the invention. The status/reset component 520 sits between the control port and one of the RCM3200 modules 502. The control port is connected to the switchboard of the workstation at various locations, including the workstation's status LED and the workstation's power switch. The status/reset component 520 thus senses whether the workstation is on or off, and sends that status to the RCM3200 module 502. The status/reset component 520 also receives signals from the RCM3200 module 502 instructing it to turn off or reset the power on the workstation, which it accomplishes by causing the appropriate switches on the workstation to open and/or close.

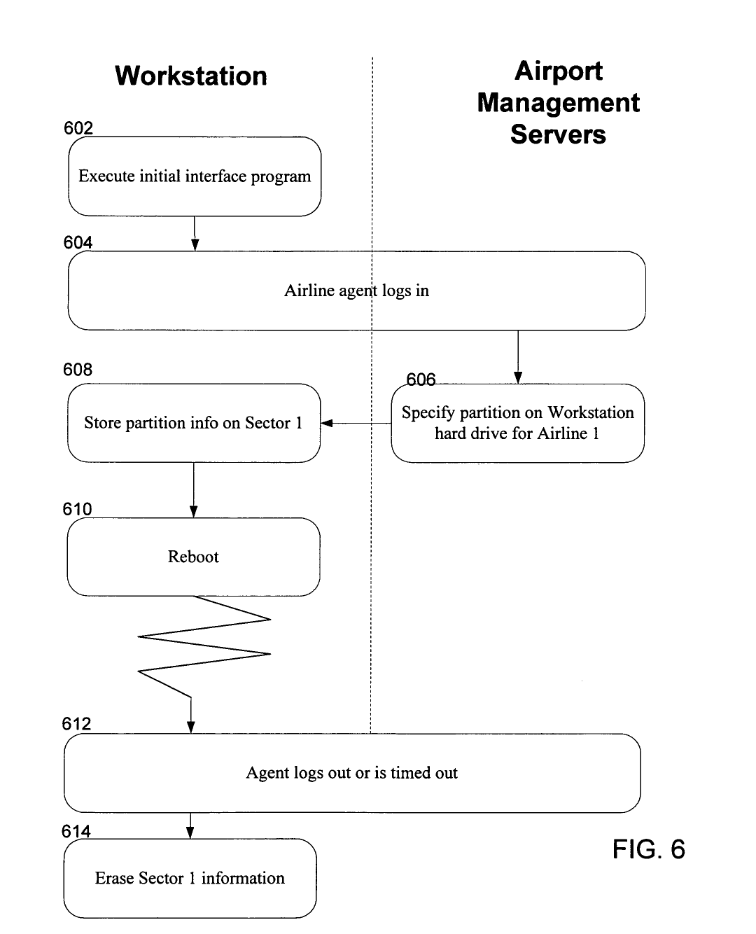

Turning attention to FIG. 6, a multi-boot operation is described for allowing multiple airlines to load their own operating systems and proprietary applications on a common workstation at an airport terminal counter, in accordance with an embodiment of the invention. In the embodiment, the workstation contains or has attached to it a hard drive storage device. The hard drive is partitioned into a plurality of partitions, such that an individual airline is assigned one of the partitions. On the airline's partition is an operating system for operating the workstation, along with any of the airline's software applications. Unlike existing common-use systems, the airline's applications do not require any modification in order to function on the common workstation and with the attached common peripherals.

Many existing partitioning systems place a limit on the number of partitions available on a hard drive. Furthermore, many existing partitioning systems require a global description of the drive's partitions, usually found in a Master Boot Record at Sector 1 (LBA 0). Such a global description can compromise the privacy of partitions, since any application running from any partition can access the global information contained on Sector 1 (LBA 0). An embodiment of the invention has the advantage of overcoming these drawbacks by ensuring that an airline may only access its designated partition. Instead of statically storing the hard drive's partition information at the physical Sector 1 (LBA 0), the drive's partition information is stored remotely, for example, at the airport management servers. A Master Boot Record for an airline is created to describe the hard drive as follows: a lower partition takes up all the space below the airline's designated partition and is marked as type 66—unknown; a middle partition is the space allocated for the airline software and operating system and is marked active; a top partition takes up all the space above the airline's designated partition and is marked as type 66—unknown. An initial interface program is executed at the common workstation at step 602. When an airline representative logs in using the initial interface program at step 604, the drive's partition information is sent from the remote servers to the common workstation at step 606 and is physically stored on Sector 1 (LBA 0) of the hard drive at step 608. However, the partition information received only contains references for that particular airline; no information is stored regarding the location of other airlines' partitions on the hard drive, thus preserving the privacy of the system. The workstation then reboots at step 610, reading the newly stored hard drive information from Sector 1 (LBA 0), and loading the airline's operating system and applications from the described partition. When the airline representative eventually logs out at step 612, either voluntarily or via a system-initiated reset, the Sector 1 (LBA 0) information is erased at step 614.

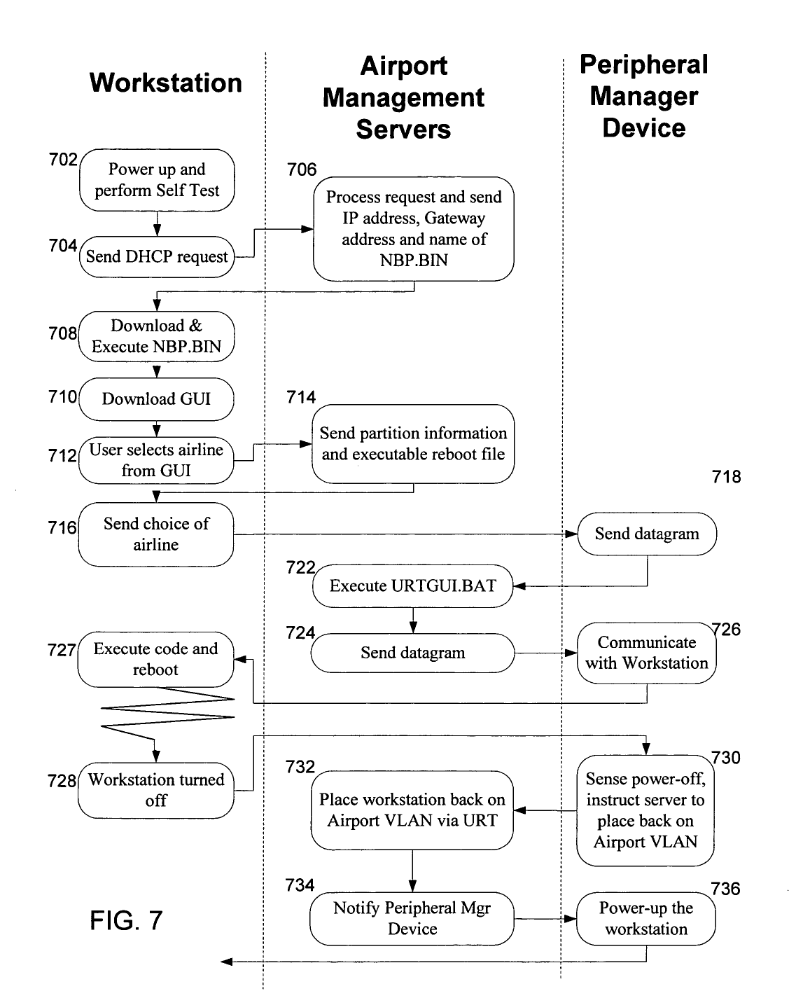

In more detail, a method for using a multi-boot system in a common-use airport terminal equipment scenario, as used in an embodiment of the invention, is now described with reference to FIG. 7. An advantage of a multi-boot system such as the one described is that it allows airlines to load their own operating systems and proprietary software applications on the common-use terminal equipment, rather than requiring airlines to emulate their applications on an airport-provided operating system. The multi-boot system as described also offers the advantage of privacy for individual airlines, whose assigned disk partition is inaccessible to others. The method begins with a workstation powering-up and performing a Power-On Self Test at step 702. The workstation then uses Pre-boot Execution Environment (PXE) software that is stored on its BIOS to send a DHCP request over the network at step 704. The request is forwarded to the airport management servers where, at step 706, it sends back to the workstation an IP address, gateway address, and the name of a network bootstrap program file (nbp.bin) to download and execute.

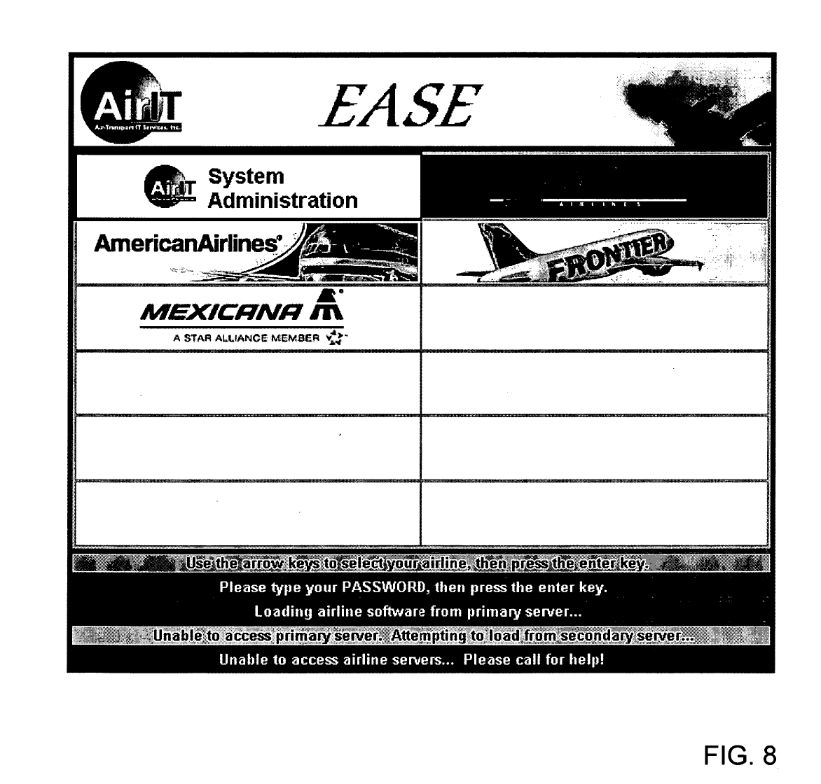

After receiving the reply from the airport management servers, the workstation downloads and executes the nbp.bin file at step 708, which in turn downloads a graphical user interface (GUI) program at step 710. A user then selects an airline from a graphical user interface on the workstation at step 712. A sample graphical user interface is shown in FIG. 8. The GUI contains a list of available airlines, from which the user makes his selection. The airport management servers are thus able to control which individual airlines are allowed to access the particular workstation by only displaying login options for particular airlines. In response to the user's selection, the workstation downloads code at step 714 for instructing the workstation to begin the boot process from a corresponding partition on the workstation's hard drive. The code writes the appropriate partition information for the selected airline into the master boot record (LBA 0) of the hard drive prior to booting the workstation. Alternatively, the code instructs the workstation to boot from a network boot server. The workstation does not execute the code at this point, however.

Instead, the method continues by initiating VLAN switching using URT as follows. The workstation sends a message to the peripheral device manager via a serial link at step 716, telling it which airline has been selected. At step 718, the peripheral device manager in turn sends a TCP datagram to an interface program on the airport management server. The interface program then executes a urtgui.bat script at step 722, which moves the workstation into the proper VLAN for the selected airline by assigning its particular MAC address to the VLAN. Alternatively, in SNMP managed networks, the urtgui.bat script issues SNMP Set requests. When the script finishes, the interface program, at step 724, sends a TCP datagram back to the peripheral device manager. The peripheral device manager notifies the workstation, via a serial link, that it can now execute the code it retrieved for beginning the boot process, at step 726. The workstation executes the retrieved code and reboots at step 727, loading the operating system and applications from the designated airline's partition and accessing the peripheral devices via the peripheral manager device.

The workstation remains on the airline's VLAN running the airline's software until the workstation is turned off at step 728. At step 730, the peripheral device manager senses the workstation's power has been turned off, and sends a request to the interface program running on the airport management servers to place the workstation back on the airport management VLAN. The airport management servers fulfill this request using URT as described above, at step 732, and the interface notifies the peripheral management device at step 734. The peripheral management device then causes the workstation to power-on via its control interface, at step 736.

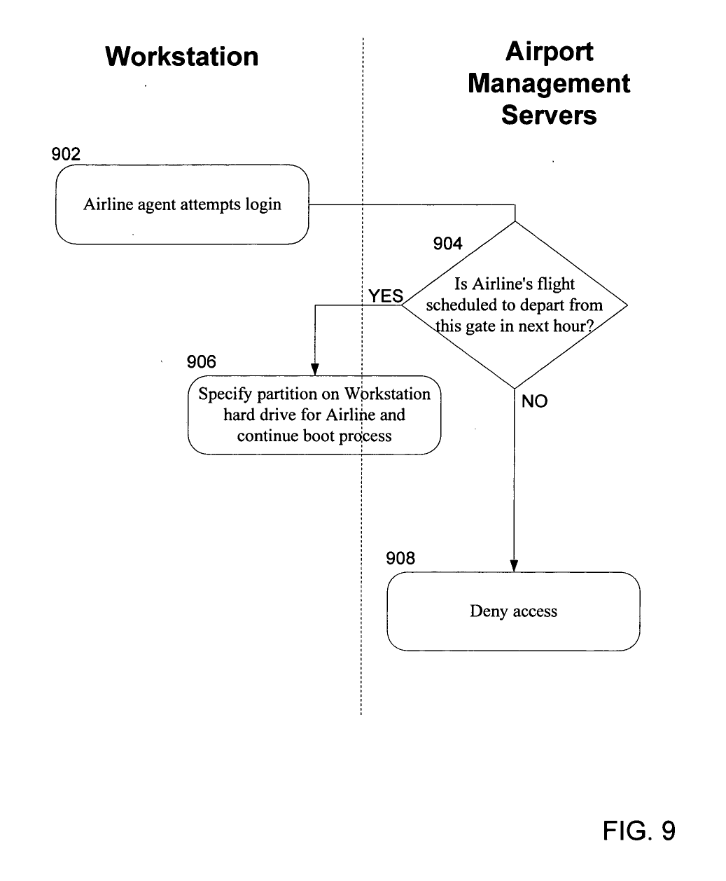

In an embodiment of the invention, an airport resource manager functioning with the airport management servers 114 coordinates airline use of the common workstation 100. The resource manager can be tied-in to the management of other airport management aspects, such as flight arrival/departure information, gate allocation, ticket counter allocation, baggage claim assignment, etc. The use of one exemplary resource manager is shown in FIG. 9. A representative of Airline A attempts to login to the common workstation located at a gate for a departing flight at step 902. The airline representative uses via a graphical user interface like the one shown in FIG. 8. Before granting access and specifying a hard drive partition, using the resource manager 120 running on the airport management servers 114, the airport management servers 114 check that the gate is currently assigned to Airline A, and that a flight is scheduled to depart from the gate at step 904. If so, the airport management servers 114 grant access and specify partition information at step 906, in accordance with the method described with reference to FIG. 7. Otherwise, the airport management servers 114 deny access to Airline A at step 908. In this manner, access to the workstation and peripherals is coordinated in real-time with gate allocation; if a flight is cancelled or a gate is changed suddenly, the workstation 100 may no longer be available to an airline.

In view of the many possible embodiments to which the principles of the present invention may be applied, it should be recognized that the embodiments described herein with respect to the drawing figures are meant to be illustrative only and should not be taken as limiting the scope of the invention. For example, the invention is not limited to application within airport terminals: other transportation terminals hosting multiple transportation carriers are contemplated, such as bus terminals and train terminals. Additionally, those of skill in the art will recognize that the illustrated embodiments can be modified in arrangement and detail without departing from the spirit of the invention. Although the invention is described in terms of software modules or components, those skilled in the art will recognize that such may be equivalently replaced by hardware components. Therefore, the invention as described herein contemplates all such embodiments as may come within the scope of the following claims and equivalents thereof.

What is claimed is:

1. A system for managing operations at a station of a transportation terminal, the station operable by any of a plurality of transportation carriers, the system comprising:
a computing device;
a peripheral manager device connected to the computer; and
at least one peripheral device attached to the peripheral manager;
wherein an operating system and set of applications corresponding to a first of the plurality of transportation carriers are loaded onto the computing device; and wherein the peripheral manager device is switched to a mode facilitating communication between the at least one peripheral device and the loaded set of applications on the computing device.

2. The system of claim 1 wherein the operating system and set of applications are loaded from a respectively designated partition of a local hard drive on the computing device.

3. The system of claim 1 wherein the computing device comprises a network interface initially connected to a transportation terminal management server.

4. The system of claim 3 wherein the operating system and set of applications are loaded onto the computing device in response to information received from the transportation terminal management server.

5. The system of claim 3 wherein the network interface of the computing device is reassigned to be in secure communications with a private network of the first transportation carrier.

6. A method for managing operations at a station of a transportation terminal, the station operable by any of a plurality of transportation carriers, the method comprising:
selecting a first transportation carrier from a user interface on a computer located at the station;
a computing device;
loading, by the computer, an operating system and applications corresponding to the first transportation carrier;
notifying a peripheral manager device connected to the computer of the selection of the first transportation carrier; and
facilitating, by the peripheral manager, communication between the applications loaded on the computer and at least one peripheral device connected to the peripheral manager.

7. The method of claim 6 further comprising:
switching, by the peripheral manager, a network connection of the computer to a private network of the first transportation carrier.

8. The method of claim 6 further comprising:
sensing, by the peripheral manager, the power status of the computer; and
the peripheral manager causing the computer to reboot.

9. A peripheral manager apparatus for facilitating communication between at least one peripheral device and a computer, the computer operable by any of a plurality of transportation carriers, the apparatus comprising:
a communications interface connected to the computer;
a peripheral interface connected to the at least one peripheral device; and
a controller receiving a signal corresponding to a first of the plurality of transportation carriers, and intermediating communications between the communications interface and the peripheral interface such that applications of the first transportation carrier, residing on the computer, communicate with the at least one peripheral device.

10. The apparatus of claim 9 further comprising a first network interface for connecting to a first virtual local area network containing a centralized transportation terminal management server.

11. The apparatus of claim 10 further comprising a second network interface for connecting to a second virtual local area network containing a server corresponding to the first transportation carrier.

12. The apparatus of claim 9 further comprising a control interface connected to the computer, the control interface controlling power to the computer.

13. The apparatus of claim 12 wherein the control interface causes the computer to reboot.

14. The apparatus of claim 9 wherein the at least one peripheral device is a baggage tag printer, bar code reader, gate reader, or report printer.

15. The apparatus of claim 9 wherein the communications interface comprises at least one COM interface.

16. The apparatus of claim 9 wherein the communications interface comprises a universal serial bus (USB) interface.

17. The apparatus of claim 9 wherein the peripheral interface comprises at least one serial ¢ interface.

18. A system for managing resources of a transportation terminal including a gate for use by a plurality of transportation carriers, the system comprising:
a network for managing resources of the transportation terminal;
a computer associated with the gate and connected to the network; and
an access server connected to the network granting or denying access to computer;
wherein granting or denying access to the computer is performed for one of the plurality of transportation carriers in congruence with managing other resources of the transportation terminal.

19. The system of claim 18 wherein, upon being granted access, one of the plurality of transportation carriers loads a respective operating system and set of applications from a respectively designated partition of a local hard drive associated with the computer.

20. The system of claim 19 further comprising a peripheral manager facilitating communication between at least one peripheral device and the loaded set of applications on the computer.
